(19) United States
(12) Patent Application Publication
(10) Pub. No.: US 2002/0026288 A1
(43) Pub. Date: Feb. 28, 2002

(54) Chip, genomic drug prescription support system, chip information offering system, chip supply system,and computer storage medium

(76) Inventors: Yoshikatsu Ueda, Kawasaki (JP); Kazuna Nozato, Chiba (JP); Megumu Kondo, Kawasaki (JP)

Correspondence Address: Mattingly, Stanger & Malur, P.C., Suite 370, 1800 Diagonal Road, Alexandria, VA, 22314, US

(21) Appl. No.: 09/920,833

(22) Filed: Aug. 3, 2001

(30) Foreign Application Priority Data
Aug. 22, 2000 (JP) 2000-250533

(51) Int. Cl. G06M 11/04

(52) U.S. Cl. 702/127

(57) ABSTRACT

A chip, a genomic drug prescription support system, a chip information offering system, a chip supply system and a computer storage medium are provided for providing appropriate prescription support information concerning a genomic drug to be prescribed based on the genetic information of an individual. The chip 18 has probes 16 selectively disposed thereon for acquiring genetic information necessary for prescribing a genomic drug which is to be prescribed based in the genetic information of an individual.

### BACKGROUND OF THE INVENTION

The present invention relates to a chip, a genomic drug prescription support system, a chip information offering system, a chip supply system, and a computer storage medium and, more particularly, to a chip, a genomic drug prescription support system, a chip information offering system, a chip supply system, and a computer readable medium, for providing helpful information supporting the prescription of a genomic drug in response to the genetic information of an individual.

In the art, the annex to a drug generally contains particular mention of the dose in children as a method of use thereof and/or, under the heading “cautions” the cautions to be observed when a patient having an allergic constitution or a pregnant patient takes the drug.

### SUMMARY OF THE INVENTION

The genome project, or genomic sequencing, is in progress in various animal species with the recent rapid advances in gene technology. In particular, a number of researchers are engaged in the “human” genome project and the decipherment of the whole nucleotide sequence information is only a matter of time. The analysis of functions expressed by nucleotide sequences is also in progress and some genes highly associated with particular diseases have been identified. It is expected that the accumulation of such information will result in approval of medicines (genomic drugs) in the near future, which are to be prescribed according to the genetic information of each individual patient so that each individual patient may be treated based on the genetic information thereof (i.e. specifically tailormade treatment).

In prescribing such a genomic drug, however, it is necessary to analyze the genetic information of each individual as to whether there is the risk of an adverse effect or the desired effect can be expected with each individual genomic drug.

In the present state of genetic engineering, chips are in general use in nucleotide sequence decipherment. Currently, the probes to be borne by these chips are selected based on such indices as the relevant diseases and the origin and similarity of the nucleotide sequence. Therefore, the probes are not suited as means for judging, in the future, whether a particular genomic drug to be prescribed to a patient will be adequate or not.

In view of the problems mentioned above, it is an object of the present invention to provide a chip, a genomic drug prescription support system, a chip information offering system, a chip supply system, and a computer recording medium, for providing helpful information supporting the prescription of a genomic drug in response to the genetic information of an individual.

The chip of the invention is selectively provided with probes for acquiring therefrom the genetic information which is necessary for prescribing a genomic drug based on the genetic information of an individual.

When the genetic information contains the information as to whether there is (are) a medicine(s) to be prohibited from being taken concomitantly with a certain genomic drug, it is possible to get, based on the genetic information of an individual patient, information as to the medicine(s) to be prohibited from being taken concomitantly.

Further, when the above genetic information contains genetic information relative to the possibility of the genomic drug producing a side effect or effects, then it is possible to know information relative to the possibility of manifestation of a side effect or effects based on the genetic information of an individual patient.

When the above genetic information contains genetic information concerning the efficacy and/or the level thereof or nonefficacy of the genomic drug, it is possible to acquire information concerning the efficacy and/or the level thereof or nonefficacy of the genomic drug based on the genetic information of an individual patient.

The genomic drug prescription support system of the present invention comprises pattern input means for inputting nucleotide sequence hybridization pattern information, pattern judging means for acquiring, from the pattern information input by the pattern input means, genetic information necessary for prescribing a genomic drug to be prescribed based on the genetic information of an individual, and output means for outputting prescription supporting information for prescribing the genomic drug based on the genetic information obtained by the pattern judging means.

When the above output means outputs information concerning the existence or nonexistence of a medicine to be prohibited from being taken concomitantly, it is possible to acquire such information based on the genetic information of an individual patient.

When the above output means outputs information concerning a possible side effect or effects, such information can be known based on the genetic information of an individual patient.

When the above output means outputs information concerning the efficacy and/or level thereof or nonefficacy, such information can be acquired based on the genetic information of an individual patient.

Alternatively, the genomic drug prescription support system of the invention comprises information input means for inputting the genetic information of an individual and output means for outputting prescription supporting information for a given genomic drug based on the genetic information input by the information input means.

The chip information offering system of the invention comprises sales information input means for inputting the sales information on a chip sold on which probes for acquiring genetic information necessary for prescribing a genomic drug, which is to be prescribed based on the genetic information of an individual, are selectively disposed, and information offering means for offering, to the purchaser of the chip, information for deriving prescription support information on the corresponding genomic drug from the hybridization pattern readable from the chip.

The chip supply system of the invention comprises stock monitoring means for monitoring the number of chips in stock on which probes for acquiring genetic information necessary for prescribing a genomic drug, which is to be prescribed based on the genetic information of an individual, are selectively disposed, and chip order means for detecting that the stock of chips as monitored by the stock monitoring means has become low and for giving an order for the supply of the chips accordingly. The invention is further concerned with a computer recording medium which carries a program recorded thereon to cause a computer to function as a genomic drug prescription support system comprising: pattern input means for inputting nucleotide sequence hybridization pattern information; pattern judging means for acquiring genetic information necessary for prescribing a genomic drug to be prescribed based on the genetic information of an individual from the pattern information input by the pattern input means; and output means for outputting prescription support information concerning the genomic drug based on the genetic information obtained by the pattern judging means.

The invention is also directed to a computer recording medium which carries a program recorded thereon to cause a computer to function as a genomic drug prescription support system comprising: information input means for inputting the genetic information of an individual; and output means for outputting prescription support information concerning a given genomic drug based on the genetic information input by the information input means.

The invention still further relates to a computer recording medium which carries a program recorded thereon to cause a computer to function as a chip information offering system comprising: sales information input means for inputting the sales information concerning a chip sold on which probes for acquiring genetic information necessary for prescribing a genomic drug, which is to be prescribed based on the genetic information of an individual, are selectively disposed; and information offer means for offering, to the purchaser of the chip, information for deriving prescription support information on the corresponding genomic drug from the hybridization pattern readable from the chip.

These and other objects, features and advantages of the present invention will become more apparent in view of the following detailed description of the preferred embodiments in conjunction with accompanying drawings.

### BRIEF DESCRIPTION OF THE DRAWINGS

FIG. 1 is a representation of the information on related nucleotide sequences which is required in making a chip in accordance with an embodiment of the invention;

FIG. 2 is a representation of the information on actions which is required in making a chip in accordance with an embodiment of the invention;

FIG. 3 is a diagram illustrating the process for making a chip in accordance with an embodiment of the invention;

FIG. 4 is a diagram schematically illustrating a mode of prescription supporting using a chip in accordance with an embodiment of the invention;

FIG. 5 is a block diagram illustrating the constitution of a genomic drug prescription support system in accordance with an embodiment of the invention;

FIG. 6 is a flowchart illustrating the operation of a genomic drug prescription support system in accordance with an embodiment of the invention;

FIG. 7 is a block diagram illustrating the function of a chip information offering system in accordance with an embodiment of the invention; and

FIG. 8 is a block diagram illustrating the function of a chip supply system in accordance with an embodiment of the invention.

### DESCRIPTION OF THE PREFERRED EMBODIMENTS

In the following, certain preferred embodiments of the invention are described in detail referring to the accompanying drawings.

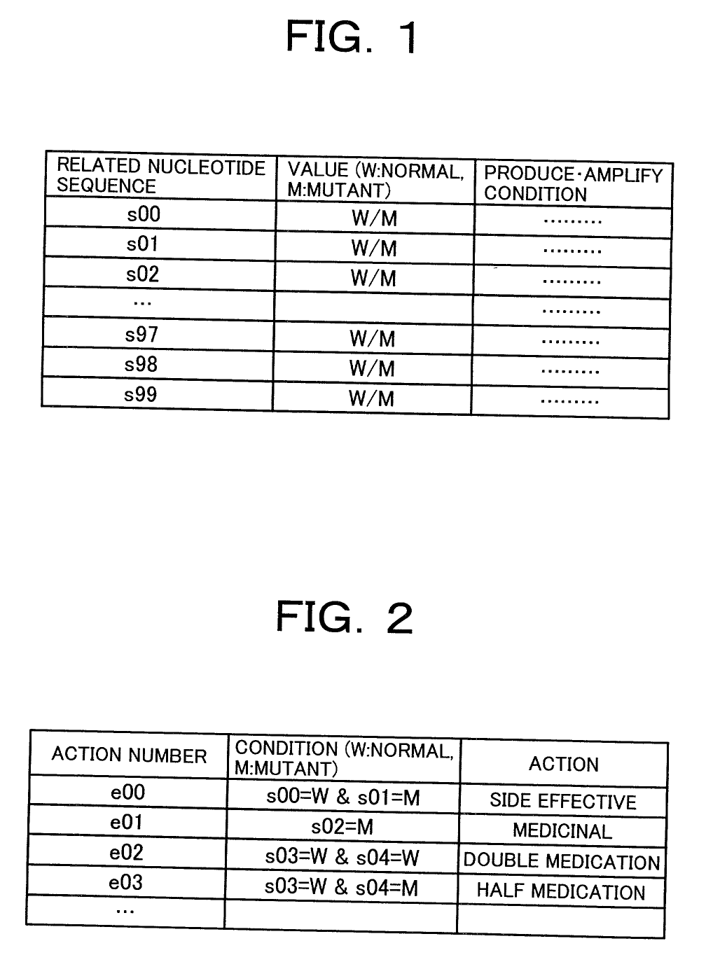

FIG. 1 is a representation of the information on related nucleotide sequences which is required in making a chip in accordance with an embodiment of the invention. When the prescription of an appropriate medicine/reagent depends on the polymorphism (W: wild or normal; M: mutant) of the nucleotide or nucleotide sequence at a given position or site in a given nucleotide sequence for which the preparation/amplification conditions are known, the given nucleotide sequence is included in the list of related nucleotide sequences (s00-s99). Among the preparation/amplification conditions, there are the primer set=<primer, primer>, temperature conditions=<temperature, time−temperature, time−. . . >, and enzyme.

FIG. 2 is a representation of the information on actions which is required in making a chip in accordance with an embodiment of the invention. In the stage of clinical trial in drug creation, a pharmaceutical company administers a candidate medicine to a number of volunteers and gathers the information on actions while taking into consideration the related nucleotide sequences (genetic types of the volunteers etc., s00-s99) of the volunteers and judging as to whether there is a correlationship between the related nucleotide sequences and the results of taking the medicine. The information on actions is obtained, for example, as shown in FIG. 2, in the manner such that a side effect is observable in a patient for whom the related nucleotide sequence value s00 is W and the value s01 is M.

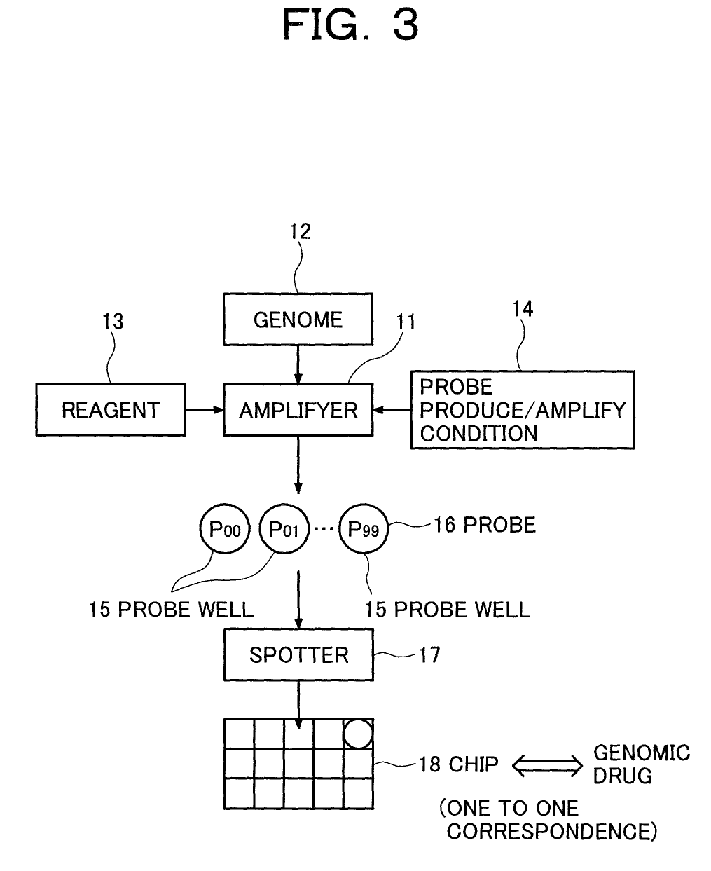

FIG. 3 is a diagram illustrating the process for making a chip in accordance with an embodiment of the invention. The chip is made to be having probes which enables to distinguish the polymorphism of nucleotide sequences of patient which determine actions of the genomic drug. In a chip manufacturing plant, a probe corresponding to each related nucleotide sequence is prepared on the drug basis based on the related nucleotide sequence information. First, in a preliminary treatment step, a genome 12 is taken from the blood or the like of a human using a reagent 13. A probe 16 is a nucleotide sequence obtained from the genome 12 by selective amplification 11 of a nucleotide sequence that hybridizes with the related nucleotide sequence in an environment satisfying given production/amplification conditions 14. The probe 16 is produced in a probe well 15 and the probe 16 is disposed on the chip 18 using a spotter 17.

The chip 18 is prepared for each drug. The chip 18 is sent to a hospital where the drug is to be used.

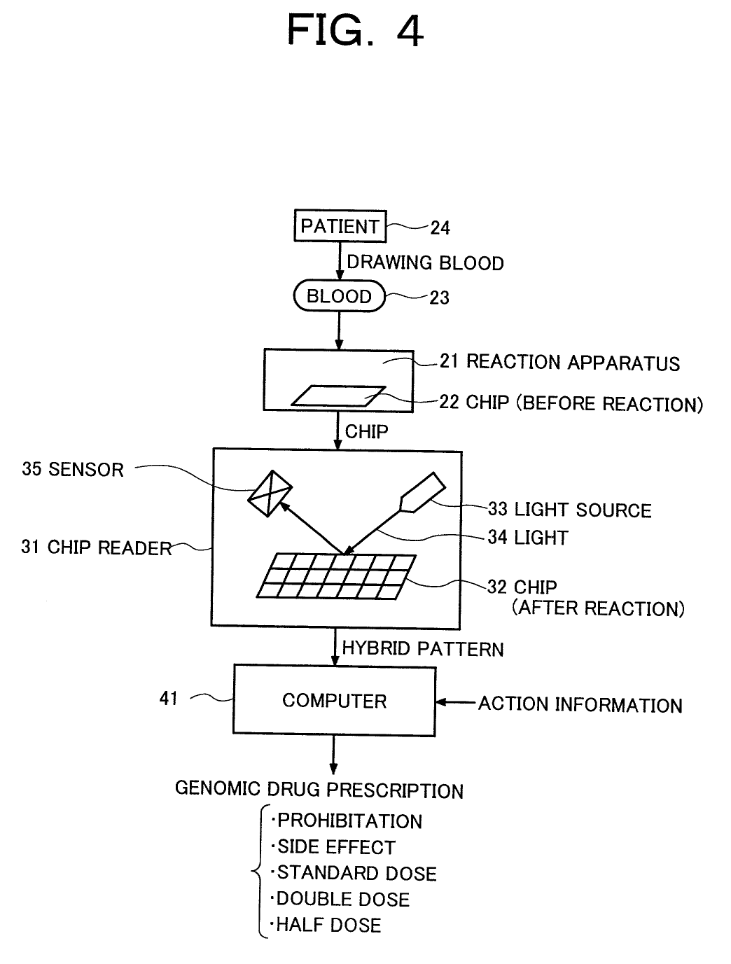

FIG. 4 is a diagram schematically illustrating a mode of prescription supporting using a chip in accordance with an embodiment of the invention. When a drug is to be prescribed, the blood 23 sampled from a patient 24 is supplied to a reaction apparatus (hybridizer) 21 and allowed to react with a chip (before reaction) 22 corresponding to the medicine.

For example, the messenger RNA which is extracted by the blood and labeled by fluorescence is supplied to the hybridizer under a certain condition that enables distinguishing the polymorphism of the nucleotide sequence. Then, on a chip reader 31, the chip (after reaction) 32 is irradiated with a predetermined light 34 from a light source 33. Whether each related nucleotide sequence on the chip 32 has emitted light or not is read by a sensor 35. In this way, the hybridization pattern is determined. The pattern information is given to a computer 41 connected with the chip reader 31 and the computer 41 determines and displays prescription support information for action based on the conditions specified in the action information (cf. FIG. 2). The action information, as described above, shows the relationship between related nucleotide sequences and the results of taking the medicine. On the other hand, the hybridization pattern information shows the polymorphism of related nucleotide sequences of the patient for whom the medicine is going to be prescribed. Therefore, by combining the action information and the hybridization pattern of the patient, the result of taking the medicine particular to the patient is obtained.

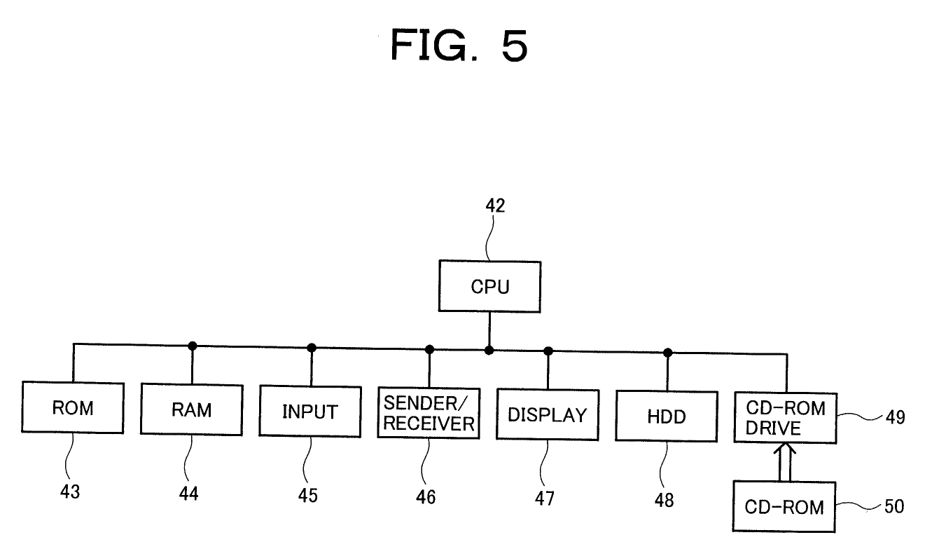

FIG. 5 is a block diagram illustrating the constitution of a genomic drug prescription support system in accordance with an embodiment of the invention. This system comprises a computer 41 which includes a CPU 42, a ROM 43, a RAM 44, an input unit 45, a sender/receiver 46, a display 47, a hard disk drive 48 and a CD-ROM drive 49. A rewritable CD-R or CR-RW may be used as a recording medium instead of the CD-ROM 50. In that case, a CD-R or CD-RW drive is provided instead of the CD-ROM drive 49. In a further constitution, a DVD, ZIP, MO or PD and a medium therefor may be used, together with a corresponding drive, as an information holding medium instead of the CD-ROM drive 49.

The CPU 42 controls the whole genomic drug prescription support system in accordance with a program stored in the ROM 43, RAM 44 or hard disk drive (HDD) 48 and executes a genomic drug prescription support process, which is to be mentioned later herein. The ROM 43 stores a program or the like necessary for instructing processing necessary for the operation of the genomic drug prescription support system. The RAM 44 temporarily stores data necessary for executing the genomic drug prescription support processing. The input unit 45 consists of a keyboard or mouse, for instance, and is used for conditions necessary for executing the genomic drug prescription support system, among others. The sender/receiver 46 executes data sending/receiving processing based on the instruction of the CPU 42 via a communication line.

The display 47 executes a process of displaying the hybridization pattern input or the prescription support information, which is an action output as a result of prescription support processing, for instance, based on an instruction from the CPU 42. The hard disk drive (HDD) 48 stores a genomic drug prescription support program, action information (cf. FIG. 2) and the like, reads out a program or data or the like stored therein based on an instruction from the CPU 42 and stores the same in the RAM 43, for instance. The CD-ROM drive 49 reads out a program or data or the like from the genomic drug prescription support program, action information and so on stored in the CD-ROM 50 in accordance with an instruction from the CPU 42 and stores the same in the hard disk drive (HDD) 48, for instance.

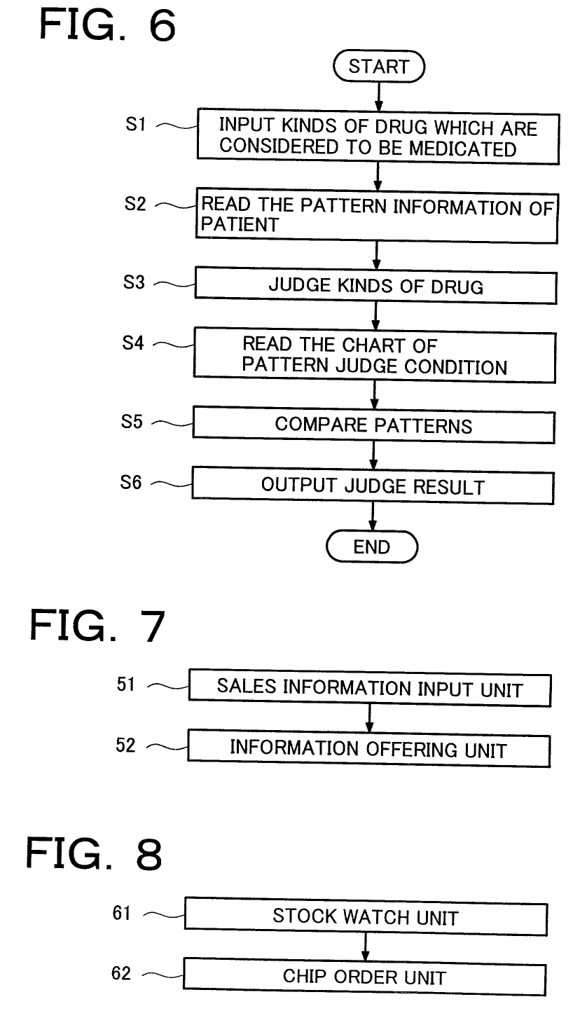

FIG. 6 is a flowchart illustrating the operation of a genomic drug prescription support system in accordance with an embodiment of the invention. First, the kinds of drugs which are under examination for administration to a patient are input in the input unit 45 (step S1). On the other hand, the hybridization pattern information of the patient is read by the chip reader (step S2), a table of pattern judging conditions by which a kind of drug under consideration for administration is to be selected and utilized is selected (step S3), the action information in, the form of a table of pattern judging conditions, for instance, corresponding to that drug is read (step S4), the hybridization pattern of the patient is compared with the action condition hybridization pattern in the table of pattern judging conditions, namely the hybridization pattern is judged (step S5) and the action information, which is the result of pattern judgment, is output (step S6) Here, the action condition hybridization pattern shows the relationship between related nucleotide sequences and the result of taking the medicine. Therefore, by comparing the action condition hybridization pattern and the hybridization pattern of the patient, the particular result of the patient's taking of the medicine is obtained, and this is output as action information.

The output of this action information is displayed on the display 47 as contraindication, side effect, standard dose, double dose or half dose, for instance.

FIG. 7 is a block diagram illustrating the function of a chip information offering system in accordance with an embodiment of the invention. The action information explained hereinabove referring to FIG. 2 is generally prepared by a pharmaceutical manufacturer. It is needed, however, by a prescribing doctor or hospital, among others, in using the chip for judging the appropriateness of the reagent, hence it is provided basically to the purchaser of the chip. It is not necessary, however, for the purchaser to be provided with the information on each occasion of chip purchasing. Provision thereof on the first occasion of chip purchasing is sufficient. If a novel finding is obtained thereafter relative to the genomic drug, it is sufficient for the purchaser to be informed of the novel finding for updating the data. Thus, in a first example, this action information may be delivered to the chip or genomic drug purchasers listed by the chip maker or pharmaceutical manufacturer via e-mail or by mailing of a CD-ROM, for instance. In a second example, an ID or password, which serves as a data accessing right, is attached to the chip or genomic drug so that the purchaser can access a home page by inputting this ID or password and get the action information by downloading, for instance. This home page method can provide the action information on the genomic drug which reflects the newest findings at the occasion of use of the chip.

The chip information offering system for that purpose can be realized by a computer of the same type as shown in FIG. 5 and comprises, for instance, a sales information input unit 51 for inputting the sales information about the chips sold, and an information offer unit 52 for providing information for deriving the corresponding genomic drug subscription support information from the hybridization pattern given by the chip to the purchasers based on the sales information. The input unit 51 consists of a keyboard, for instance, and, on each occasion of chip sale, the purchaser's address, name, E-mail address and so forth are input, together with the sales information, by an operator by means of keys. The information offer unit 52 may be an E-mail sender for sending the action information via E-mail or a printer or display device for instructing mailing of a CD-ROM carrying the action information recorded thereon. When the above-mentioned home page method is employed, the information offer unit 52 may be a unit for carrying out processing to enable access to a home page by means of an ID or password.

FIG. 8 is a block diagram illustrating the function of a chip supply system in accordance with an embodiment of the invention. Generally, the chip maker is a company different from the pharmaceutical manufacturer. Further, it is not necessary to use the chip for judging as to the appropriateness of a drug on each occasion of administration but the reagent once judged to be appropriate for administration to a patient can be administered to the patient continuously for a certain period of time. Therefore, the chip and drug need not be dispatched in combination but may be sent forth separately. Therefore, it is advisable that the number of chips in stock be monitored independently of the drug by recording the inventory resulting from purchasing and the like and the retrieval resulting from consumption and the like and, when it is detected that the stock is below a predetermined level as a result of consumption of chips, an order be given for the chips to thereby have the chips delivered and maintain the stock within a predetermined range. This system for maintaining the stock within a predetermine range may be located in a hospital or the like for ordering from a chip maker, or in a chip maker for controlling the stock in a hospital or the like by remote monitoring and giving an in-house order for dispatch.

The chip supply system therefor can be realized by a computer of the same type as shown in FIG. 5 and comprises, for example, a stock watch unit 61 for monitoring the number of chips in stock, and a chip order unit 62 for giving an order for the supply of chips when such stock monitoring means as mentioned above detects that the stock is below a predetermined level. When the chip order unit 62 is located within a hospital, it may be an E-mail sender for giving an order for the supply of chips to a chip maker or a printer or display device instructing mailing of an order. When it is within a chip maker, the chip order unit 62 may be a printer for printing a slip instructing a person actually in charge of chip dispatching to dispatch chips or a display device instructing such chip dispatch.

It is to be noted that the embodiments mentioned above are never limitative of the scope of the present invention.

The genomic drug or medicine so referred to herein broadly includes not only those drug or medicines which are used for the treatment of diseases but also those which are used for prophylactic purposes, for example vaccines.

The chip, genomic drug prescription support system and computer storage medium of the invention each shows one-to-one correspondence with the given genomic drug. It is not necessary, however, to supply or sell both in set but the drug alone may be sold or the chips alone may be sold.

The genomic drug may be a conventional one provided that this can be adequately prescribed based on the genetic information of an individual, and the chip and so on corresponding to that genomic drug fall within the scope of the present invention.

The genetic information includes such genetic information according to which a discrimination can be made between the past tolerance to a drug or medicine and the current intolerance to the same drug or medicine due to the onset of hypertension. Namely, it includes such genetic information of one and the same person as is variable from time to time.

When the genetic information of a patient is already known, it is unnecessary to use the chip of the invention and the known genetic information may be input directly into an input unit of a computer to thereby output prescription support information relative to the given genomic drug.

As described hereinabove, the present invention can provide appropriate prescription support information concerning a genomic drug to be prescribed based on the genetic information of an individual.

While the present invention has been described above in conjunction with the preferred embodiments, one of ordinary skilled in the art would be enabled by this disclosure to make various modifications to this embodiment and still be within the scope and spirit of the present invention as defined in the appended claims.

What is claimed is:

1. A chip which comprises probes selectively disposed thereon for acquiring genetic information necessary for prescribing a genomic drug, which is to be prescribed based on the genetic information of an individual.

2. The chip as claimed in claim 1, wherein the genetic information includes genetic information concerning the existence or nonexistence of a drug or medicine to be prohibited from being taken concomitantly with the genomic drug.

3. The chip as claimed in claim 1, wherein the genetic information includes genetic information concerning the possibility of a side effect of the genomic drug.

4. The chip as claimed in claim 1, wherein the genetic information includes genetic information concerning the efficacy or nonefficacy of the genomic drug.

5. A genomic drug prescription support system which comprises:
pattern input means for inputting nucleotide sequence hybridization pattern information;
pattern judging means for acquiring genetic information necessary for prescribing a genomic drug to be prescribed based on the genetic information of an individual from the pattern information input by the pattern input means; and
output means for outputting prescription support information concerning the genomic drug based on the genetic information obtained by the pattern judging means.

6. The genomic drug prescription support system as claimed in claim 5, wherein the output means outputs information concerning the existence or nonexistence of a drug or medicine to be prohibited from being taken concomitantly with the genomic drug.

7. The genomic drug prescription support system as claimed in claim 5, wherein the output means outputs information concerning the possibility of a side effect of the genomic drug.

8. The genomic drug prescription support system as claimed in claim 5, wherein the output means outputs information concerning the efficacy or nonefficacy of the genomic drug.

9. A genomic drug prescription support system which comprises:
information input means for inputting the genetic information of an individual; and
output means for outputting prescription support information concerning a given genomic drug based on the, genetic information input by the information input means.

10. A chip information offering system which comprises:
sales information input means for inputting the sales information concerning a chip sold on which probes for acquiring genetic information necessary for prescribing a genomic drug, which is to be prescribed based on the genetic information of an individual, are selectively disposed; and
information offering means for offering, to the purchaser of the chip, information for deriving prescription support information on the corresponding genomic drug from the hybridization pattern readable from the chip.

11. A chip supply system which comprises:
stock watch means for monitoring the number of chips in stock on which probes for acquiring genetic information necessary for prescribing a genomic drug, which is to be prescribed based on the genetic information of an individual, are selectively disposed; and
chip order means for detecting that the stock of chips as monitored by the stock monitoring means has become low and for giving an order for the supply of the chips accordingly.

12. A computer storage medium which carries a program recorded thereon to cause a computer to function as a genomic drug prescription support system, comprising:
pattern input means for inputting nucleotide sequence hybridization pattern information;
pattern judging means for acquiring genetic information necessary for prescribing a genomic drug to be prescribed based on the genetic information of an individual from the pattern information input by the pattern input means; and
output means for outputting prescription support information concerning the genomic drug based on the genetic information obtained by the pattern judging means.

13. A computer storage medium which carries a program recorded thereon to cause a computer to function as a genomic drug prescription support system comprising:
information input means for inputting the genetic information of an individual; and
output means for outputting prescription support information concerning a given genomic drug based on the genetic information input by the information input means.

14. A computer storage medium which carries a program recorded thereon to cause a computer to function as a chip information offering system, comprising:
sales information input means for inputting the sales information concerning a chip sold on which probes for acquiring genetic information necessary for prescribing a genomic drug, which is to be prescribed based on the genetic information of an individual, are selectively disposed; and
information offering means for offering, to the purchaser of the chip, information for deriving prescription support information on the corresponding genomic drug from the hybridization pattern readable from the chip.

15. A chip which comprises probes selectively disposed thereon for acquiring genetic information necessary for prescribing a genomic drug, wherein said probes are nucleotide sequences which hybridize with related nucleotide sequences that determine actions of the genomic drug.

16. A genomic drug prescription support system comprising:
a memory for storing action information which shows the relationship between related nucleotide sequences and the results of taking the genomic drug;
pattern input means for inputting hybridization pattern information which shows the polymorphisms of related nucleotide sequences of a patient for whom the drug is going to be prescribed;
pattern judging means for comparing said action information with said hybridization pattern information and obtaining the result of taking the drug particular to the patient; and
output means for outputting prescription support information concerning the genomic drug based on the result obtained by the pattern judging means.

17. A method of making a chip for acquiring genetic information necessary for prescribing a genomic drug comprising:
taking a genome from a human;
obtaining probes from the genome by selectively amplifying nucleotide sequences which hybridize with the related nucleotide sequences that determine actions of the genomic drug;
placing probes on the chip.

18. The method of making a chip according to claim 17, wherein the genome is taken from the blood of the human.

19. A method for providing prescription information of a genomic drug comprising:
storing action information which shows the relationship between related nucleotide sequences and the results of taking the genomic drug;
inputting hybridization pattern information which shows the polymorphisms of related nucleotide sequences of a patient for whom the drug is going to be prescribed;
comparing said action information with said hybridization pattern information and obtaining the result of taking the drug particular to the patient; and
outputting prescription information concerning the genomic drug based on the result.

20. A computer storage medium which carries a program recorded thereon to cause a computer to function as a genomic drug prescription providing system, comprising:
storing means for storing action information which shows the relationship between related nucleotide sequences and the results of taking the genomic drug;
input means for inputting hybridization pattern information which shows the polymorphisms of related nucleotide sequences of a patient for whom the drug is going to be prescribed;
comparing means for comparing said action information with said hybridization pattern information and obtaining the result of taking the drug particular to the patient; and
output means for outputting prescription information concerning the genomic drug based on the result.

20. A computer program to cause a computer to function as a genomic drug prescription providing system, comprising:
storing means for storing action information which shows the relationship between related nucleotide sequences and the results of taking the genomic drug;
input means for inputting hybridization pattern information which shows the polymorphisms of related nucleotide sequences of a patient for whom the drug is going to be prescribed;
comparing means for comparing said action information with said hybridization pattern information and obtaining the result of taking the drug particular to the patient; and
output means for outputting prescription information concerning the genomic drug based on the result.

21. A computer storage medium which carries a program recorded thereon to cause a computer to function as a genomic drug prescription providing system, comprising steps of:
storing action information which shows the relationship between related nucleotide sequences and the results of taking the genomic drug;
inputting hybridization pattern information which shows the polymorphisms of related nucleotide sequences of a patient for whom the drug is going to be prescribed;
comparing said action information with said hybridization pattern information and obtaining the result of taking the drug particular to the patient; and
outputting prescription information concerning the genomic drug based on the result.
